(19) United States
(12) Patent Application Publication
(10) Pub. No.: US 2012/0013743 A1
(43) Pub. Date: Jan. 19, 2012

(54) Device for Monitoring Condition of a Railway Supply Line

(75) Inventors: Francesc Tanarro Marquez, Barcelona (ES); Pau Gratacos Marti, Badalona (ES); Francisco Javier Sanchez Pujadas, Barcelona (ES); Joan Ramon Jimenez Minguell, Sabadell (ES); Jacobus Antens, Sabadell (ES); Enric Sala I Esteva, Sant Feliu De Guixols (ES)

(73) Assignee: ALSTOM TRANSPORT SA, Levallois-Perret (FR)

(21) Appl. No.: 13/177,017

(22) Filed: Jul. 6, 2011

(30) Foreign Application Priority Data
Jul. 7, 2010 (EP) 10305756.8

(51) Int. Cl. B43L 13/10; H04N 7/18

(52) U.S. Cl. 348/148; 33/23.01; 348/E07.085

(57) ABSTRACT

The present invention provides a monitor for monitoring a condition of a railway supply line when the supply line is in contact with a head of a pantograph of a vehicle in order to power the vehicle. The monitor includes a camera for monitoring parameters indicative of operating capability of the railway supply line and a reflective element including a pattern arranged on the pantograph head. The camera is arranged on the vehicle so as to register the pattern position with respect to a vertical direction. A pantograph and a vehicle are also provided.

This claims the benefit of European Patent Application No. 10350756.8 filed on Jul. 7, 2010 and hereby incorporated by reference herein.

The present invention relates to a device for monitoring condition of a railway supply line (also called contact line or overhead line), when said supply line is in contact with a head of a pantograph of a vehicle in order to power said vehicle.

### BACKGROUND

A device for monitoring condition of a railway supply line is known from prior art, in particular from JP 2001-235310. This device includes a camera for monitoring parameters indicative of operating capability of said supply line.

In JP 2001-235310, the vehicle includes a pantograph provided with a measurement element comprising a support and a slider intended to slide along the supply line. The slider is connected with the support by means of springs. The slider and the support each hold an infrared light source, so that the camera is intended to register the relative position of the light sources regarding a vertical direction.

### SUMMARY OF THE INVENTION

Since the measurement element is arranged between the pantograph and the supply line, this pantograph cannot be used during commercial service, due to safety issues, in particular due to risks of electric shock.

One of the objects of the invention provides a device for monitoring condition of a railway supply line, easy to implement, which allows the pantograph to be used during commercial service when monitoring condition of the supply line.

The present invention provides a device for monitoring condition of a railway supply line when the supply line is in contact with a head of a pantograph of a vehicle in order to power said vehicle, said device including a camera for monitoring parameters indicative of operating capability of said supply line, characterized in that the device includes a reflective element, comprising a pattern, intended to be arranged onto the pantograph head, the camera being intended to be arranged on the vehicle so as to register the pattern position regarding a vertical direction.

Such a reflective element can be arranged onto the pantograph head without any change on this pantograph, so that said pantograph still can be used for power the vehicle. Thus, the invention may make it possible to monitor condition of a railway supply during commercial service of railway vehicles.

Moreover, any railway vehicle can be equipped with the monitoring device. Thus, by equipping several service trains running on a railway, it may be possible to continuously monitor condition of the railway supply line.

Other features of the monitoring device of the invention may include the following:
the device comprises calculating means for processing said monitored parameters to determine whether said parameters are changing relative to reference values and to determine whether the changes are indicative of an increased risk of a malfunction in said supply line;
the device comprises a Global Positioning System, intended to localize a defect on the supply line when the calculating means determine that there is a risk of a malfunction;
the calculating means are intended to calculate the acceleration of the vertical moves of the pantograph head, by comparing successive captures, and to calculate the force that the pantograph applies on the supply line, based on this acceleration;
the camera is a linear camera, configured so as to deliver at least 1000 measures per second;
the pattern of the reflective element comprises at least two horizontal strips, made of a retro-reflective material;
the camera comprises a movable lens, by tilting or shifting;
the device comprises an infrared light source, directed toward the reflective element, and the camera comprises a filter tuned at the same wave length as the infrared light source.

The present invention further provides a pantograph having a head intended to be in contact with a railway supply line, the pantograph comprising a reflective element, having a pattern.

The invention also provides a vehicle having a pantograph comprising a pantograph head intended to contact a railway supply line in order to power said vehicle, the vehicle comprising a device as disclosed above.

### BRIEF DESCRIPTION OF THE DRAWINGS

Other aspects and advantages of the invention will become apparent on reading the following description which is given by way of example and refers to the attached drawings in which:

FIG. 1 is a schematic representation of a vehicle equipped with a device of the invention,

FIG. 2 is a schematic representation of the device that equips the vehicle of FIG. 1, and

FIG. 3 is a front view of a reflective element of the device of FIG. 2.

### DETAILED DESCRIPTION

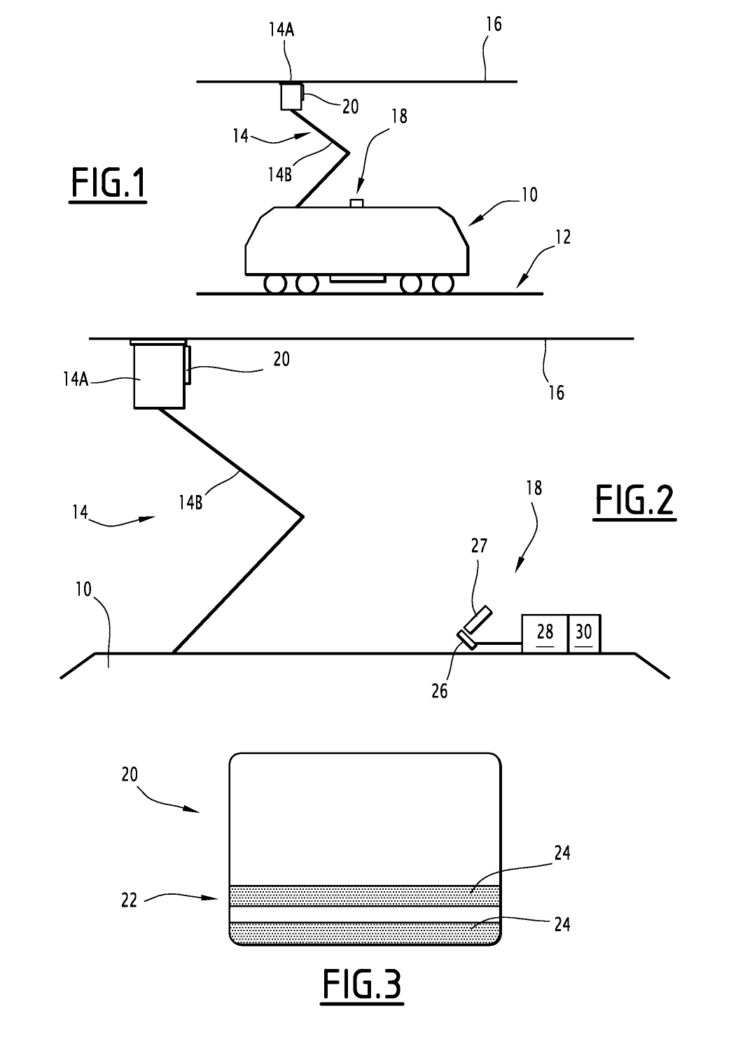

With reference to FIG. 1 we describe a vehicle 10 intended to run on a railway 12.

The vehicle 10 is an electric train, which comprises at least one pantograph 14, intended to collect current from a supply line 16 of the railway 12, also called catenary 16, in order to power the electric train 10. To this end, the pantograph 14 comprises a pantograph head 14A, intended to contact the supply line 16 and to slide along this supply line 16. The pantograph 14 also comprises an articulated arm 14B, intended to hold the pantograph head 14A. The articulated arm 14B acts as a spring for pressing the pantograph head 14A against the supply line 16.

For maintenance reasons, it is important to monitor parameters indicative of operating capability of said supply line 16, in particular in order to detect defects of the supply line 16. A current monitored parameter is the force that the pantograph 14 applies to the supply line 16, that can be deducted from the moves of the pantograph head 14A regarding a vertical direction.

To this end, the vehicle 10 is equipped with a monitoring device for example, a monitor 18 for monitoring condition of the railway supply line 16 when said supply line 16 is in contact with the pantograph head 14A.

The monitor 18 includes a reflective element 20, shown on FIG. 2, arranged onto the pantograph head 14A. The reflective element 20 is preferably glued on the pantograph head 14A. For example, the reflective element 20 is a reflective sticker.

Preferably, the reflective element 20 is easy to install or to replace on the pantograph head 14A, and preferably does not requires structural changes of the pantograph head 14A. Moreover, since no stress is applied to the reflective element 20, said reflective element 20 requires low maintenance.

The reflective element 20 comprises a passive pattern 22, and does not include an emissive element. For example, the pattern 22 may include at least two horizontal strips 24, made of a retro-reflective material, i.e. a material able to reflect incident light rays so that each reflected light rays is reflected approximately in the opposite direction of the corresponding incident light ray.

The moves of the horizontal strips 24 regarding the vertical direction are the same as the moves of the pantograph head 14A regarding this vertical direction. Thus, it is possible to monitor the moves of the pantograph head 14A by monitoring the moves of the pattern 22.

To this end, the monitor 18 also includes a camera 26, arranged on the vehicle 10. The camera 26 focus is on the pantograph head 14A so as to register the position of the pattern 22 regarding the vertical direction.

Advantageously, the camera 26 may be a linear camera, i.e. a camera whose sensors are aligned along the vertical direction, so that the captures are only linear.

The camera 26 is a high resolution camera, so that the camera can detect pattern 22 moves in less than 1 mm increments. Thus, the monitoring of the moves of the pantograph head 14A may be very accurate.

The camera is configured so as to deliver at least 1000 captures per second. Since each capture corresponds to a portion of the supply line 16, a high number of captures per second makes it possible to monitor portions of the supply line 16 that are very close to each other, even on a high speed vehicle 10. So, because of this high sample frequency, the monitor 18 can be used on a high speed vehicle 10.

Camera 26 comprises a movable tilt and shift lens. Tilt is a movement of the lens so that the plane of the lens is tilted relative to a plane of sensors of the camera. Shift is a movement of the lens parallel to the plane of the sensors. Tilt and shift movements guarantee a sufficient depth of field in order to obtain sharp images of the pattern 22.

Advantageously, the monitor 18 comprises an infrared light source 27, arranged near the camera 26 and directed toward the reflective element 20. In this case, the camera 26 comprises a filter tuned at the same wave length as the infrared light source 27, in order to cancel the visible light. Preferentially, the wave length of the infrared light source 27 is approximately 960 nm.

Thus, the camera 26 only detects the light from the infrared light source 27, which is reflected on the reflective element 20. So, the camera captures are not influenced by the environmental light, especially by the light of the sun, which has a low gain in said wave length.

Besides, the monitor 18 comprises a calculating device, for example, a calculator 28, which may be a computer with some dedicated hardware, connected to the camera 26. The calculator 28 is intended to process said monitored parameters, i.e. the moves of the pantograph head 14A, in order to determine whether said parameters are changing relative to reference values and to determine whether the changes are indicative of an increased risk of a malfunction in said supply line.

Prior to any calculation, the calculator 28 is calibrated, using a reference pattern, which delimits a work range for the measures, and the bounds of said work range. The work range is usually the same as the range of movements of the supply line 16, i.e. about 1500 mm, and the bounds of the work range are correspond to the lower and higher positions of the supply line 16.

Once the work range and the bounds are defined, the vertical position of pantograph head 14A is measured regarding the reference pattern. When the train 10 is moving, this position varies during the time.

Making the derivation of the measured position referred to the time, the speed of pantograph head 14A is obtained in a vertical direction.

Following the same process, deriving the speed, the acceleration of said pantograph head 14A is obtained in the vertical direction. With this parameter, following Newton's second law, it is possible to obtain the force applied by the pantograph head 14A on the supply line 16, by multiplying said acceleration by the equivalent mass of the pantograph head interacting with said supply line (F=m*a). This equivalent mass is classically obtained from the pantograph static uplift force.

Another calculating method can be used when the interaction between the supply 16 and the pantograph head 14A is known and already modeled. Indeed, it is possible to obtain differential equation of the dynamic behavior of the pantograph head 14A, and to take this equation as a reference. The three derivatives on said equation are equivalent to vertical position, speed and acceleration.

With three samples from the online measures, it is possible to calculate, in real time, three parameters of the differential equation. Comparing if these parameters are inside the tolerance bounds, highly accurate monitoring may be achieved.

Advantageously, monitoring the progressive deviation of these parameters due to wearing of the supply line and the pantograph, it is possible to establish a model of failure prediction. It uses a large number of measures to establish this model.

Advantageously, the camera 26 is also configured to detect electric sparks between the pantograph 14 and the supply line 16, when the contact between said pantograph 14 and said supply line 16 is broken.

Advantageously, the monitor 18 comprises Global Positioning System (GPS) 30, connected to the calculator 28. Thus, when the calculator 28 determines that there is a risk of a malfunction, the Global Positioning System 30 determines the position of the vehicle 10 onto the railway 12, and informs a maintenance department about the localization of the defect on the supply line 16.

So, the maintenance department can operate a preventive maintenance action onto portions of the supply line 16 where a defect is detected, in order to avoid failures in these defective portions of the supply line 16.

It should be noticed that, since the monitor 18 can be installed on any vehicle 10, it is advantageous to install such monitors 18 on several service vehicles, in order to continuously monitor the condition of the supply line 16 during a commercial service.

The present invention allows monitoring the supply line 16 condition, without contact, thus avoiding electrical issues.

The present invention is not limited to the embodiment disclosed above. In particular, the reflective element 20 can comprise a pattern different from the two horizontal strips.

What is claimed is:

1. A monitor for monitoring a condition of a railway supply line when the railway supply line is in contact with a head of a pantograph of a vehicle in order to power the vehicle, the monitor comprising:
a camera for monitoring parameters indicative of an operating capability of the railway supply line; and
a reflective element including a pattern arranged on the pantograph head,
the camera being arranged on the vehicle so as to register a pattern position with respect to a vertical direction.

2. The monitor according to claim 1, further comprising a calculator for processing the monitored parameters to determine whether the monitored parameters are changing relative to reference values and to determine whether the changes are indicative of an increased risk of a malfunction in the railway supply line.

3. The monitor according to claim 2, further comprising a Global Positioning System that localizes a defect on the railway supply line when the calculator determines that there is a risk of a malfunction.

4. The monitor according to claim 2, wherein the calculator calculates an acceleration of the vertical moves of the pantograph head by comparing successive captures, and calculates a force that the pantograph applies on the railway supply line based on the acceleration.

5. The monitor according to claim 1, wherein the camera is a linear camera.

6. The monitor according to claim 1, wherein the pattern of the reflective element includes at least two horizontal strips.

7. The monitor according to claim 1, wherein the camera includes a movable lens.

8. The monitor according to claim 1, further comprising an infrared light source directed toward the reflective element and a filter for the camera tuned at a same wave length as the infrared light source.

9. A pantograph of a vehicle comprising:
a pantograph head contacting a railway supply line in order to power the vehicle; and
a reflective element having a pattern.

10. A vehicle having a pantograph contacting a railway supply line comprising:
a pantograph head contacting the railway supply line in order to power the vehicle; and
a monitor for monitoring a condition of the railway supply line including:
a camera for monitoring parameters indicative of an operating capability of the railway supply line; and
a reflective element including a pattern arranged on the pantograph head,
the camera being arranged on the vehicle so as to register a pattern position with respect to a vertical direction.

11. The monitor according to claim 5, wherein the linear camera delivers at least 1000 measures per second.

12. The monitor according to claim 1, wherein the reflective element includes a retro-reflective material.

13. The monitor according to claim 7, wherein the lens is movable by tilting or shifting.

14. The monitor according to claim 1, wherein the reflective element is a sticker.

15. The monitor according to claim 1, wherein a parameter being monitored includes a force the pantograph applies to the railway supply line.

16. The monitor according to claim 1, wherein the vehicle is a high speed vehicle.
